(19) United States
(12) Patent Application Publication
(10) Pub. No.: US 2026/0192673 A1
(43) Pub. Date: Jul. 9, 2026

(54) BATTERY-POWERED ARCHITECTURE FOR OFF-HIGHWAY MACHINES

(71) Applicant: Deere & Company, Moline, IL (US)

(72) Inventors: NILESH T. KUMBHAR, Karad (IN); Benjamin R. Wagner, Dubuque, IA (US); Paul A. Wantschik, Dickeyville, WI (US); Jonathan M. Peiffer, Dubuque, IA (US); Sujit S. Waghmode, Solapur (IN); Steven R. Whiteman, Dubuque, IA (US)

(21) Appl. No.: 19/011,231

(22) Filed: Jan. 6, 2025

(51) Int. Cl. B60L 1/00; B60L 53/16; B60L 53/24

(52) U.S. Cl. CPC B60L 1/003; B60L 53/16; B60L 53/24; B60L 2200/40; B60L 2210/12; B60L 2210/30; B60L 2210/40

(57) ABSTRACT

A system and a method control the energy provided to an off-highway machine having terrain-engagement members to move the machine and having hydraulic cylinders to position a material manipulation implement. At least one electric motor provides energy to operate a hydraulic pump coupled to the hydraulic cylinders and provides energy to drive the terrain-engagement members. In a first embodiment, a first electric motor drives the hydraulic pump, a first electric traction motor drives a first terrain-engagement member, and a second electric traction motor drives a second terrain-engagement member. In a second embodiment, a single electric motor drives a hydraulic pump and a hydrostatic (HST) pump via a gearbox. The hydraulic pump is coupled to the hydraulic cylinders. The HST pump is coupled to a first HST motor and a second HST motor that drive the terrain-engagement members.

### FIELD OF THE DISCLOSURE

This disclosure relates to a system and method for managing the power provided to the traction motors and the power provided to the hydraulic system of off-highway machines and agricultural machines using an all-electric (battery-powered) architecture.

### BACKGROUND

Off-highway machines are used to move bulk materials at construction sites and the like. Off-highway machines are also used in agriculture to prepare fields, plant and maintain crops, harvest and transport crops, and the like. The machines generally have large wheels or tracks as terrain-engagement members to enable the machines to move on uneven terrain. The machines serve as mobile support platforms for hydraulically powered implements attached to the machines. The attached implements manipulate materials. For example, certain implements engage soil or other materials and move the soil or other materials to other locations. The attached implements may push or pull the materials to different locations on the terrain using a blade such as a blade on a dozer or grader. The attached implements may remove the material from the terrain using a bucket or other similar implement and carry the material to a new location, either directly or by transferring the material to a transport vehicle such as a truck. Other types of implements include grinders that transform bulk material (e.g., trees, used concrete or pavement, or the like) into smaller sized material.

Many off-highway machines are powered by internal combustion engines (ICEs) such as diesel engines. An ICE may also be referred to herein as a prime mover. An ICE may power the wheels or tracks of the machine directly via gearboxes and the like; however, many machines drive the wheels or tracks using a hydrostatic pump that generates fluid flow to run hydrostatic motors that are connected to the wheels or tracks. The hydrostatic pump is driven by the ICE. The ICE also drives a hydraulic pump that provides hydraulic fluid flow to operate hydraulic cylinders and/or motors that operate the hydraulic powered implements attached to the machine. The ICE may drive the hydraulic pump directly or may drive the hydraulic pump indirectly via the hydro static pump.

Because of environmental concerns and economical concerns, all-electric (battery-powered) technology is becoming more common in transportation vehicles such as personal vehicles and smaller trucks; however, all-electric technology is less commonly used in off-highway machines.

### SUMMARY

A need exists for incorporating all-electric technology into off-highway machines.

One aspect of the embodiments disclosed herein is a system and a method that control the energy provided to an off-highway machine having terrain-engagement members to move the machine and having hydraulic cylinders to position a material manipulation implement. At least one electric motor provides energy to operate a hydraulic pump coupled to the hydraulic cylinders and provides energy to drive the terrain-engagement members. In a first embodiment, a first electric motor drives the hydraulic pump, a first electric traction motor drives a first terrain-engagement member, and a second electric traction motor drives a second terrain-engagement member. In a second embodiment, a single electric motor drives a hydraulic pump and a hydrostatic (HST) pump via a gearbox. The hydraulic pump is coupled to the hydraulic cylinders. The HST pump is coupled to a first HST motor and a second HST motor that drive the terrain-engagement members.

Another aspect of the embodiments disclosed herein is a power generation system for an electrically-powered off-highway machine having at least a first terrain-engagement member and a second terrain-engagement member for moving the off-highway machine over terrain and having at least one hydraulically powered implement for moving materials. The power generation system comprises an energy storage system that stores electrical energy. A power distribution system is coupled to the energy storage system to selectively provide DC electrical energy to the energy storage system and to selectively receive DC electrical energy from the energy storage system. At least one charging port is coupled to the power distribution system. The charging port is coupleable to a source of electrical energy to charge the energy storage system via the power distribution system. A hydraulic pump converts mechanical energy to hydraulic energy. The hydraulic pump is coupled to the hydraulically powered implement to provide the hydraulic energy to the hydraulically powered implement. At least one electric motor receives electrical energy from the energy storage system via the power distribution system and generates mechanical energy to drive the hydraulic pump, the first terrain-engagement member, and the second terrain-engagement member. A control system is configured to control the power distribution system, the at least one electric motor, the hydraulic pump, and the first and second terrain-engagement members.

In certain embodiments in accordance with this aspect, the power generation system further comprises at least one inverter coupled between the power distribution system and the at least one electric motor. The inverter converts DC electrical energy from the power distribution system to AC electrical energy provided to the at least one electric motor.

In certain embodiments in accordance with this aspect, the off-highway machine includes low-voltage auxiliary devices; and the power generation system further comprises a DC-DC converter that converts DC electrical energy from the energy storage system at a first voltage to DC electrical energy at a second voltage, wherein the second voltage lower than the first voltage. The DC electrical energy at the second voltage provided to the low-voltage accessories.

In certain embodiments in accordance with this aspect, the off-highway machine includes high-voltage auxiliary devices; and the power distribution system is coupled to the high-voltage auxiliary devices to provide DC electrical energy from the energy storage system to the high-voltage auxiliary devices.

In certain embodiments in accordance with this aspect, the at least one charging port is coupled to a voltage conversion system having an input and an output. The input of the voltage conversion system is coupleable to a source of AC electrical energy. The output of the voltage conversion system is coupled to the energy storage system via the power distribution system to provide DC electrical energy to the energy storage system.

In certain embodiments in accordance with this aspect, the at least one charging port comprises an input connector coupleable to a source of DC electrical energy. The input connector is electrically coupled to the energy storage system via the power distribution system to provide DC electrical energy to the energy storage system.

In certain embodiments in accordance with this aspect, the energy storage system comprises at least one battery.

In certain embodiments in accordance with this aspect, the at least one electric motor comprises a first electric motor that provides mechanical energy to the first terrain-engagement member, a second electric motor that provides mechanical energy to the second terrain-engagement member, and a third electric motor that provides mechanical energy to the hydraulic pump. In certain embodiments, the first electric motor is a motor/generator that is selectively operable as a motor to convert electrical energy to mechanical energy to drive the first terrain-engagement member and that is selectively operable as a generator to receive mechanical energy from the first terrain-engagement member and to generate electrical energy for storage in the energy storage system; and the second electric motor is a motor/generator that is selectively operable as a motor to convert electrical energy to mechanical energy to drive the second terrain-engagement member and that is selectively operable as a generator to receive mechanical energy from the second terrain-engagement member and to generate electrical energy for storage in the energy storage system. In certain embodiments, the power generation system further comprises a first inverter and at least a second inverter. The first inverter is coupled between the power distribution system and the third electric motor. The first inverter converts DC electrical energy from the power distribution system to AC electrical energy to drive the first electric motor. The second inverter is coupled between the power distribution system and the first electric motor and the second electric motor. The second inverter operates bidirectionally to convert DC electrical energy from the power distribution system to AC electrical energy to drive at least one of the first electric motor and the second electric motor when the at least one of the first electric motor and the second electric motor is operating as a motor; and to convert AC electrical energy from the at least one of the first electric motor and the second electric motor to DC electrical energy when the at least one of the first electric motor and the second electric motor is operating as a generator.

In certain embodiments in accordance with this aspect, the power generation system further comprises a first inverter coupled between the power distribution system and the third electric motor. The first inverter converts DC electrical energy from the power distribution system to AC electrical energy to drive the first electric motor. A second inverter is coupled between the power distribution system and the first electric motor. The second inverter operates bidirectionally to convert DC electrical energy from the power distribution system to AC electrical energy to drive the first electric motor when the first electric motor is operating as a motor and to convert AC electrical energy from the first electric motor to DC electrical energy when the first electric motor is operating as a generator. A third inverter is coupled between the power distribution system and the second electric motor. The third inverter operates bidirectionally to convert DC electrical energy from the power distribution system to AC electrical energy to drive the second electric motor when the second electric motor is operating as a motor and to convert AC electrical energy from the second electric motor to DC electrical energy when the second electric motor is operating as a generator.

In certain embodiments in accordance with this aspect, the energy storage system has a first side and a second side; the first electric motor is mounted proximate to the first side of the energy storage system; and the second electric motor is mounted proximate to the second side of the energy storage system. In certain embodiments, the energy storage system has a third side orthogonal to the first side and orthogonal to the second side; and the third electric motor is mounted proximate to the third side of the energy storage system.

In certain embodiments in accordance with this aspect, the power generation system further comprises a gearbox. The at least one electric motor is coupled to the gearbox to provide mechanical energy to the gearbox. The hydraulic pump is coupled to the gearbox to receive mechanical energy from the at least one electric motor via the gearbox. At least one hydrostatic pump is coupled to the gearbox to receive mechanical energy from the at least one electric motor and to provide hydrostatic energy. A first hydrostatic motor is coupled to the at least one hydrostatic pump to receive hydrostatic energy from the at least one hydrostatic pump and to generate mechanical energy to drive the first terrain-engagement member; and a second hydrostatic motor is coupled to the at least one hydrostatic pump to receive hydrostatic energy from the at least one hydrostatic pump and to generate mechanical energy to drive the second terrain-engagement member.

Another aspect of the embodiments disclosed herein is a method of operating an electrically-powered off-highway machine having at least a first terrain-engagement member and a second terrain-engagement member for moving the off-highway machine over terrain and having at least one hydraulically powered implement for moving materials. The method comprises storing electrical energy from an energy source in an energy storage system and coupling electrical energy from the energy storage system to at least one electric motor. The at least one electric motor generates mechanical energy. The method selectively provides mechanical energy from the at least one electric motor to one or more of a hydraulic pump, the first terrain-engagement member, and the second terrain-engagement member.

In certain embodiments in accordance with this aspect, the at least one electric motor comprises a first electric motor selectively operable to provide mechanical energy to drive the hydraulic pump; a second electric motor selectively operable to provide mechanical energy to drive the first terrain-engagement member; and a third electric motor selectively operable to provide mechanical energy to drive the second terrain-engagement member.

In certain embodiments in accordance with this aspect, the method couples the at least one electric motor to a gearbox to provide mechanical energy to the gearbox; couples the hydraulic pump to the gearbox to receive mechanical energy from the at least one electric motor via the gearbox; couples at least one hydrostatic pump to the gearbox to receive mechanical energy from the at least one electric motor via the gearbox and to generate hydrostatic energy; couples a first hydrostatic motor to the at least one hydrostatic pump to receive hydrostatic energy from the at least one hydrostatic pump and to generate mechanical energy to drive the first terrain-engagement member; and couples a second hydrostatic motor to the at least one hydrostatic pump to receive hydrostatic energy from the at least one hydrostatic pump and to generate mechanical energy to drive the second terrain-engagement member.

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 illustrates a perspective view of a first embodiment of an exemplary off-highway machine into which the improvements disclosed herein can be incorporated.

FIG. 2 illustrates an elevational side view of the off-highway machine of FIG. 1 showing internal the components of a first embodiment of the all-electric architecture disclosed herein.

FIG. 3 illustrates a perspective view of the energy storage system (battery) of the off-highway machine of FIGS. 1 and 2 wherein a power distribution system and an electric power takeoff (e-PTO) motor are mounted proximate to the energy storage system, a hydraulic pump is coupled to the e-PTO motor, and first and second traction motors are mounted proximate to the sides of the energy storage system.

FIG. 4 illustrates an exploded perspective view of the energy storage system, the power distribution system, the e-PTO motor, the hydraulic pump, and the traction motors of FIG. 3.

FIG. 5 illustrates a block diagram of the all-electric architecture of the off-highway machine of FIGS. 1-4.

FIG. 6 illustrates a flowchart of the method of operating the off-highway machine represented by the block diagram of FIG. 5.

FIG. 7 illustrates a perspective view of a second embodiment of an exemplary off-highway machine into which the improvements disclosed herein can be incorporated.

FIG. 8 illustrates an elevational side view of the off-highway machine of FIG. 7 showing internal the components of the second embodiment of the all-electric architecture disclosed herein.

FIG. 9 illustrates a perspective view of the energy storage system (battery) of the off-highway machine of FIGS. 8 and 9 wherein a power distribution system and a mechanical gearbox are mounted proximate to the energy storage system, and wherein an electric motor, a hydraulic pump, and a hydrostatic pump are mechanically coupled to the gearbox.

FIG. 10 illustrates an exploded perspective view of the energy storage system, the power distribution system, the gearbox, the electric motor, the hydraulic pump, and the hydrostatic pump of FIG. 9.

FIG. 11 illustrates a block diagram of the all-electric architecture of the off-highway machine of FIGS. 7-10.

FIG. 12 illustrates a flowchart of the method of operating the off-highway machine represented by the block diagram of FIG. 11.

### DETAILED DESCRIPTION

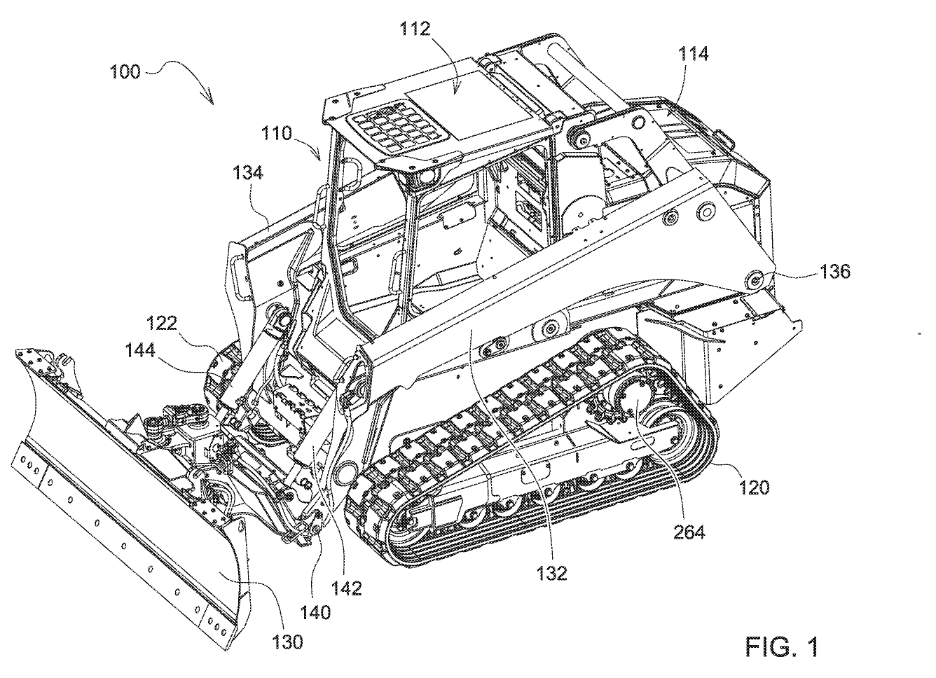

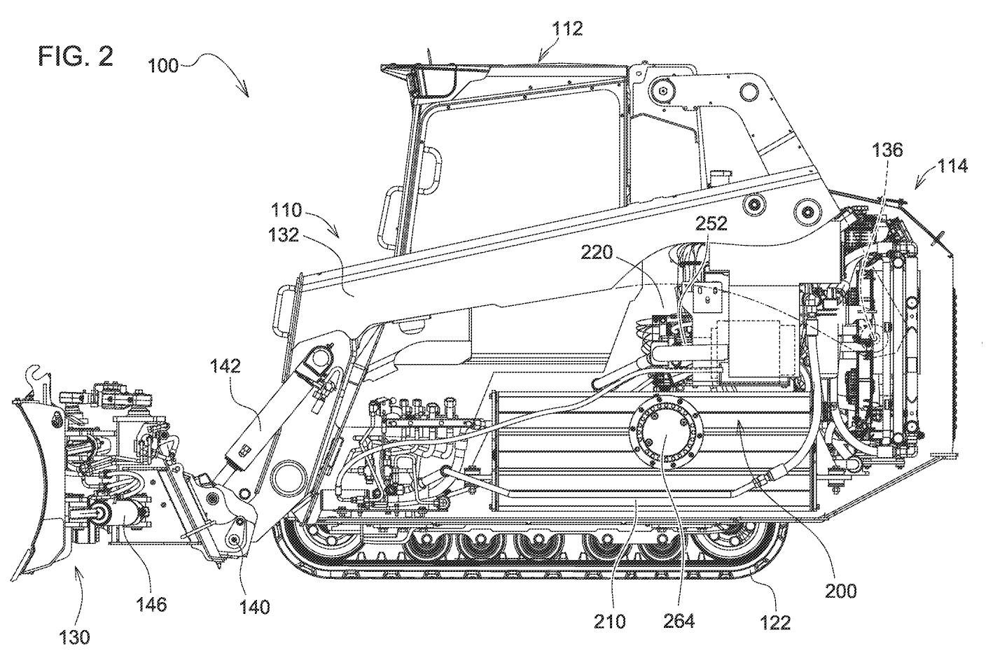

FIG. 1 illustrates a perspective view of an exemplary off-highway machine 100 into which the improvements disclosed herein may be incorporated. FIG. 2 illustrates an elevational side view of the off-highway machine of FIG. 1 with portions of machine removed to show internal components of the machine.

The illustrated off-highway machine 100 is embodied as a compact track loader (CTL) (hereinafter “loader”); however, the improvements may also be incorporated into other types of off-highway machines such as dozers, graders, excavators, earthmovers, agricultural machines, and the like. Such off-highway machines can have tracks operating as terrain-engagement members to enable the machines to move on uneven surfaces. The off-highway machines can also have large wheels instead of tracks. For example, the CTL can be implemented as a skid loader. The off-highway machines provide a movable platform for material-handling implements such as dozer blades, grader blades, loader buckets, excavator buckets that engage material such as dirt, gravel, rocks, trees, and the like, and move the material from a first location to a second location.

The illustrated loader 100 of FIG. 1 includes a main structure 110, which encompasses an operator cab 112 and a power generation compartment 114. The main structure is moved by a first terrain-engagement member 120 and a second terrain-engagement member 122, which are mounted on opposing sides of the main structure. The terrain-engagement members in FIG. 1 are illustrated as continuous tracks in the CTL embodiment. In alternative embodiments (not shown), the tracks of FIG. 1 can be replaced by a respective front wheel and a respective rear wheel on each side of the main structure to provide a skid loader configuration.

In the illustrated embodiment, the loader 100 includes a work implement 130, which is coupled to the main structure 110 via a first lifting arm 132 and a second lifting arm 134. The lifting arms are positioned on either side of the main structure. The lifting arms pivot from respective lifting arm pivots 136 located near the rear portion of the main structure. Only the lifting arm pivot on the visible side of the main structure is shown in FIG. 1. The lifting arms are raised and lowered in a conventional manner by respective hydraulic cylinders (not shown).

The work implement 130 is illustrated as a conventional dozer blade that can be pivoted about a horizontal axis with respect to respective implement pivots 140 located at a front portion of each of the lifting arms 132, 134. Only the implement pivot on the visible side is shown in FIGS. 1 and 2. The work implement is pivoted via a first pivot hydraulic cylinder 142 and a second pivot hydraulic cylinder 144. The work implement can also be swiveled about a vertical axis by a first swivel hydraulic cylinder 146. A second swivel hydraulic cylinder (not shown) can be included on the opposing side of the work implement. In other embodiments (not shown) the work implement can be, for example, a bucket that can be raised and lowered and that can also be tilted via additional hydraulic cylinders (not shown).

In a conventional loader (not shown), the terrain engagement members are driven by an internal combustion engine (ICE). For example, the ICE can drive at least one hydrostatic pump that provides hydraulic flow to at least one hydrostatic motor for each ground engagement member. The ICE also drives at least one hydraulic pump that provides hydraulic flow to operate the hydraulic cylinders to raise and lower the work implement and to tilt the work implement when the work implement is implemented as a bucket.

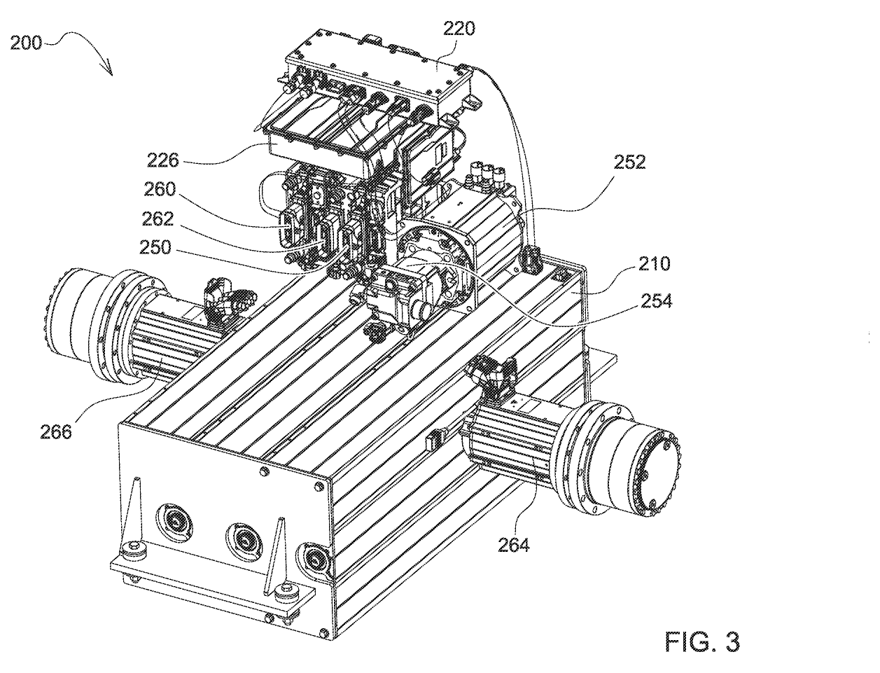

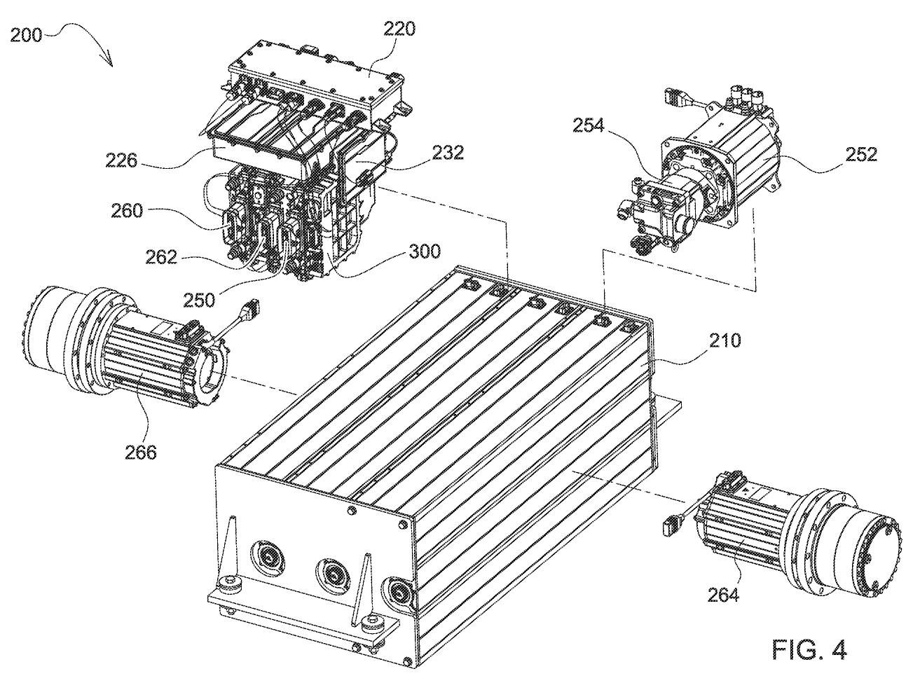

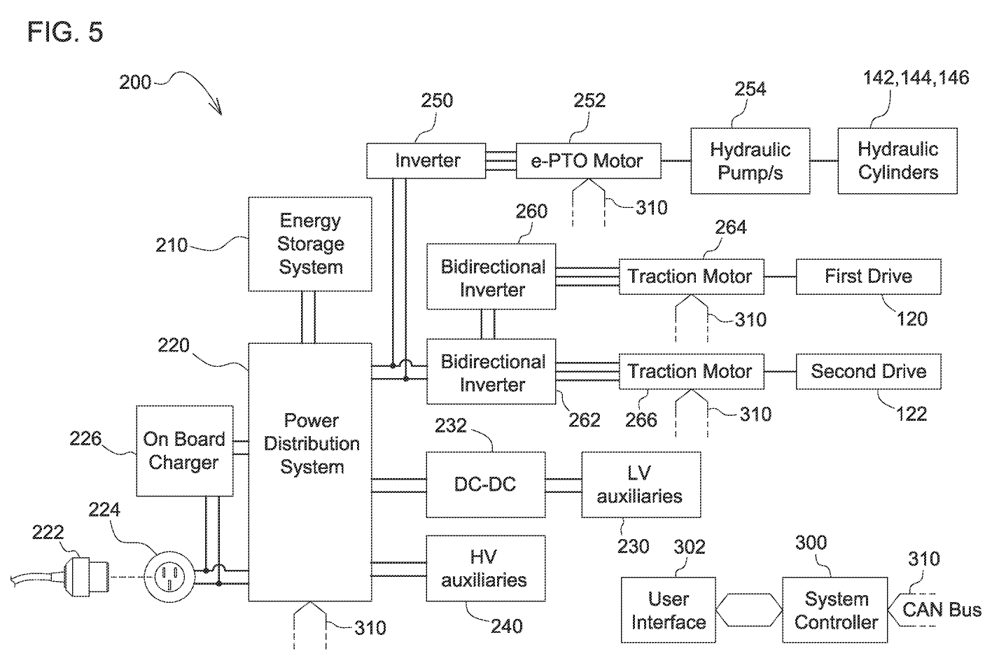

Unlike a conventional loader, the all-electric loader 100 of FIGS. 1 and 2 is configured with an all-electric power generation system 200, which is shown in a perspective view in FIG. 3, in an exploded perspective view in FIG. 4, and in a schematic block diagram in FIG. 5.

As shown in FIG. 5, the power generation system 200 includes an energy storage system 210 that receives and stores DC electrical energy and that outputs the DC electrical energy as needed. In the illustrated embodiment, the energy storage system is implemented as a battery system. For example, the energy storage system can comprise a plurality of batteries coupled together in a series-parallel configuration to provide a DC output voltage having a desired magnitude. For example, the energy storage system can have an output voltage having a magnitude that can be in a range from less than one hundred volts up to multiple hundreds of volts.

The energy storage system 210 is electrically coupled to a power distribution system 220. The power distribution system is coupled to an external energy source 222 via a charging port 224. The external source can be a DC source for rapidly charging the energy storage system. The external source can be an AC source and a voltage conversion system (on-board charger) 226 coupled to the charging port converts the AC input voltage to a DC voltage to charge the energy storage system at a slower rate. In the illustrated embodiment, the power distribution system can receive energy from either a DC source or an AC source. As shown in FIGS. 3 and 4, the power distribution system is mounted proximate to the energy storage system.

The power distribution system 220 couples the DC voltage from the energy storage system 210 to a plurality of conventional low-voltage accessories 230 such as instrumentation, communications, and the like, which operate at a conventional low-voltage level (e.g., 12 volts or greater). The voltage from the power distribution system is provided to the low-voltage accessories via a DC-DC converter 232, which converts the output voltage from the power distribution system to the conventional low-voltage level.

The power distribution system 220 also couples the DC voltage from the energy storage system 210 to a plurality of high voltage accessories 240. The high voltage accessories (e.g., heating, lighting, cooling, and the like) are configured to operate at the same voltage as the energy storage system such that no voltage conversion is needed.

The power distribution system 220 also provides DC electrical energy to a first inverter 250, which converts the DC electrical energy to AC electrical energy (e.g., three-phase AC). The AC electrical energy from the first inverter is provided to an electric power takeoff (e-PTO) motor 252, which converts the electrical energy to rotational mechanical energy. As shown in FIGS. 3 and 4, the e-PTO motor is mounted onto the energy storage system.

The rotational mechanical energy from the e-PTO motor is provided to at least one hydraulic pump (e.g., a hydraulic pump 254). In the illustrated embodiment, the hydraulic pump is mounted onto the e-PTO motor. The hydraulic pump is responsive to the rotational mechanical energy from the gearbox to produce hydraulic fluid flow. As illustrated schematically in FIG. 5, the hydraulic fluid flow is selectively coupled to the hydraulic cylinders 142, 144, 146 to move the implement 130 in a conventional manner. The hydraulic flow can also be coupled to other hydraulically powered components (not shown).

As further shown in FIG. 5, a second inverter 260 and a third inverter 262 are electrically coupled to receive DC electrical energy from energy storage system 210 via the power distribution system 220. The second inverter and the third inverter convert the DC electrical energy to AC electrical energy. The AC electrical energy from the second inverter is provided to a first traction motor 264. The AC electrical energy from the third inverter is provided to a second traction motor 266. The two traction motors are mounted to the main structure 110 proximate to opposing sides of the energy storage system. The first traction motor provides mechanical energy to the first terrain-engagement member 120. The second traction motor provides mechanical energy to the second terrain-engagement member 122. In the illustrated embodiment, the second invertor and the third inverter are separate inverters. In other embodiments , the two inverters can be implemented as a single dual inverter (not shown) having separate AC outputs for the two traction motors.

In the illustrated embodiment, the traction motors 264, 266 are implemented as motor/generators such that when the off-highway machine 100 has excess kinetic energy (e.g., when moving down a grade without moving a load), the motion of the off-highway machine is coupled to the traction motors to generate AC electrical energy and thereby provide regenerative braking. The generated AC electrical energy is converted to DC electrical energy via the second inverter 260 and the third inverter 262, which are implemented as bidirectional inverters. The converted DC electrical energy is stored in the energy storage system 210 via the power distribution system 220.

As further illustrated in FIG. 5, the all-electric power generation system 200 includes a system controller 300 coupled to a user interface 302. The user interface represents controls in the operator cab 112 that an operator can manipulate to control the operations of the loader 100. The system controller is responsive to user commands from the user interface to issue control commands to the e-PTO motor 252, to a hydraulic controller (not shown) that controls the hydraulic cylinders 142, 144, and to the traction motors 264, 266. In the illustrated embodiment, the system controller is coupled to the controlled components via a conventional controller area network (CAN) bus 310. The system controller also receives information from the controlled components via the CAN bus. The system controller is responsive to the received information to confirm proper operation of the controlled components and to make any adjustments to the operation of the controlled components.

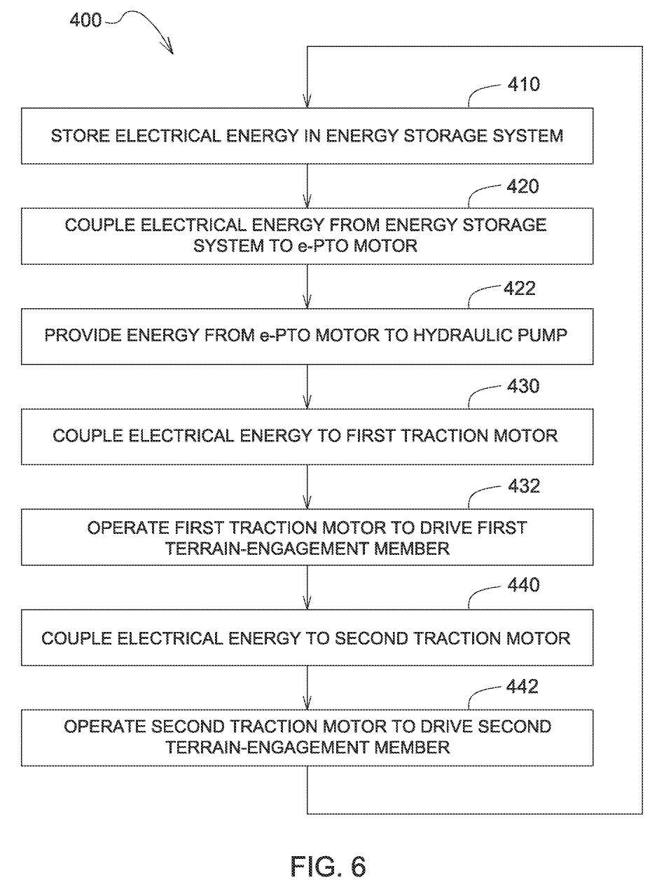

The all-electric power generation system 200 operates in accordance with a method illustrated by a flowchart 400 of FIG. 6. In a first action block 410, the method stores electrical energy from the external energy source 222 in the energy storage system 210. In a second action block 420, the method couples electrical energy from the energy storage system to a first motor (e.g., the e-PTO motor 252). In a third action block 422, the first motor is selectively operable to provide mechanical energy to drive the hydraulic pump 254. In a fourth action block 430, the method couples electrical energy from the energy storage system to a second motor (e.g., the first traction motor 264). In a fifth action block 432, the second electric motor is selectively operable to provide mechanical energy to drive the first terrain-engagement member 120. In a sixth action block 440, the method couples electrical energy from the energy storage system to a third motor (e.g., the second traction motor 464). In a seventh action block 442, the third electric motor is selectively operable to provide mechanical energy to drive the second terrain-engagement member 122. The method continues to loop in the seven action blocks and responds to commands from the system controller 300 to selectively operate the hydraulic pump and the traction motors as described above.

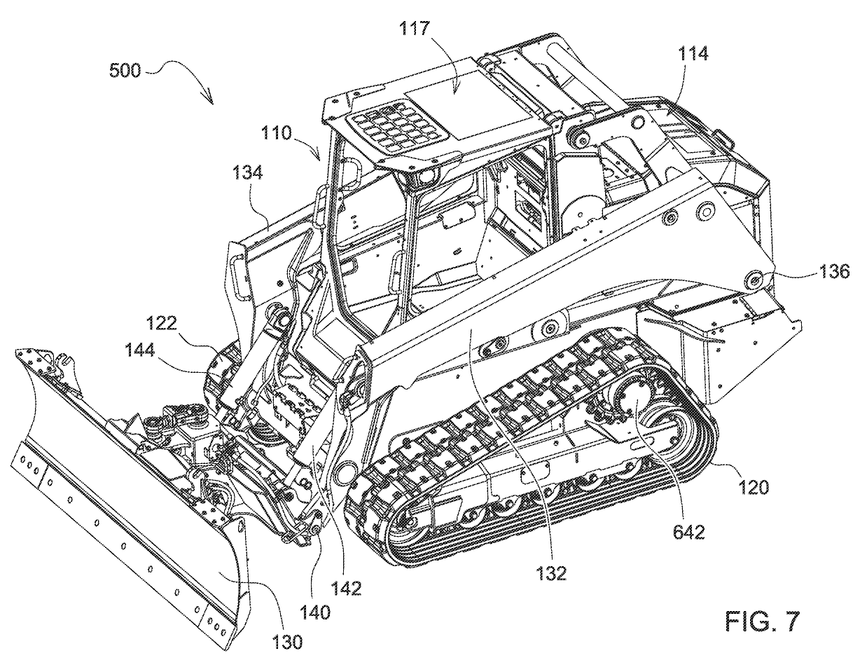

FIG. 7 illustrates a perspective view of alternative embodiment of an all-electric off-highway machine(“loader”) 500. The external elements of the embodiment of FIG. 7 are the same as the corresponding elements of FIG. 1 and are numbered the same as before. The foregoing description of FIG. 1 applies to FIG. 7.

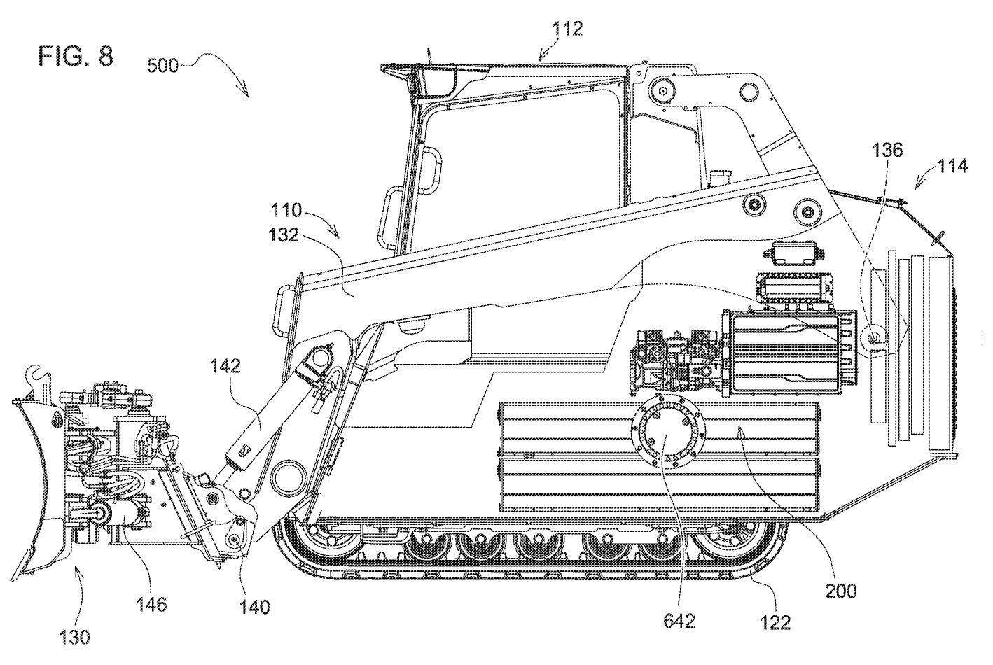

FIG. 8 illustrates a cross-sectional view of the off-highway machine 500 of FIG. 7. Many of the elements of the off-highway machine shown in the view in FIG. 8 are the same or similar to the corresponding elements of the off-highway machine shown in the view in FIG. 2. Like elements are numbered accordingly and the foregoing description of those elements in FIG. 2 apply to the elements of FIG. 8.

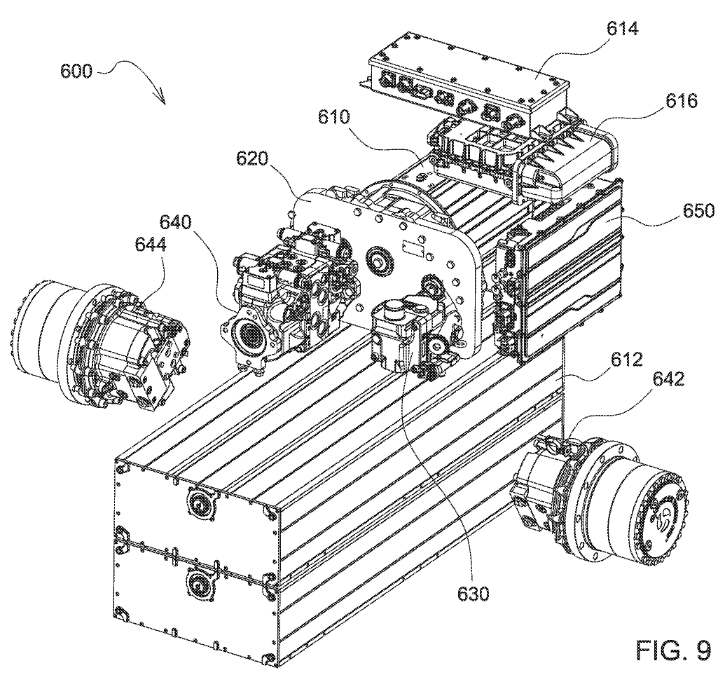

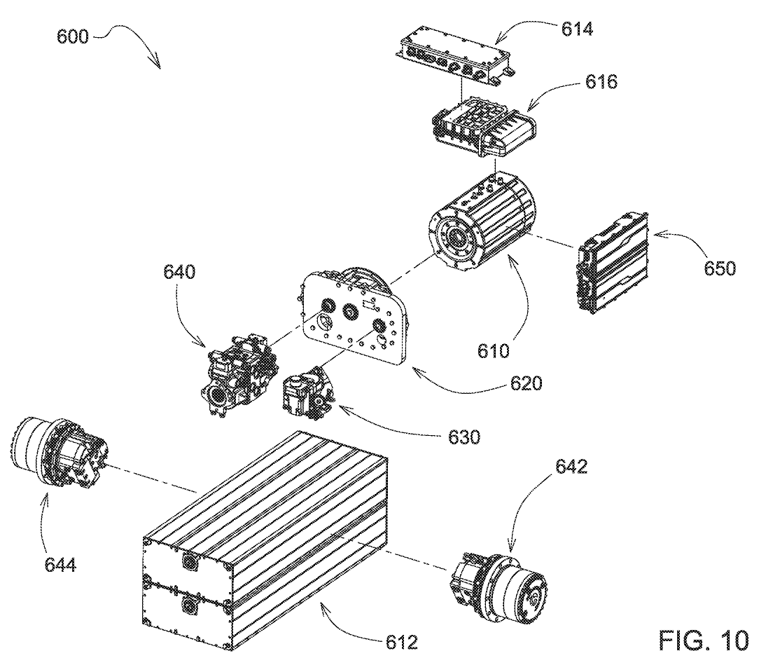

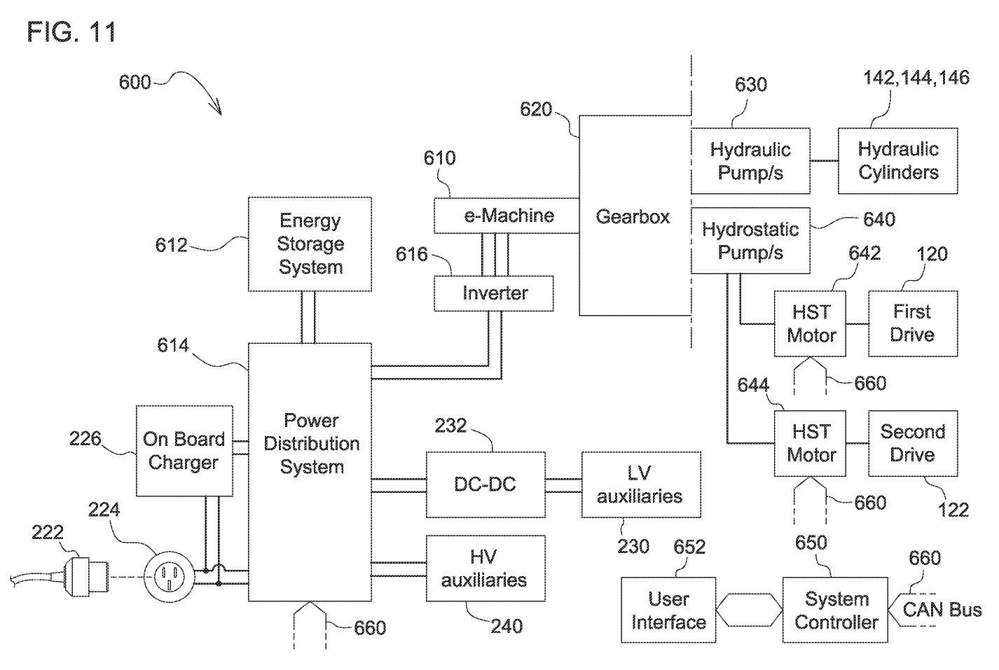

The loader 500 of FIGS. 7 and 8 is configured with an all-electric power generation system 600, which is shown in a perspective view in FIG. 9, in an exploded perspective view in FIG. 10, and in a schematic block diagram in FIG. 11.

The loader 100 of FIGS. 1 and 2 has three electric motors (the e-PTO motor 252 for driving the hydraulic pump 254, the first electric traction motor 264, and the second electric traction motor 266) in the all-electrical power generation system 200. In contrast, the all-electric power generation system 600 of the loader 500 operates with a single electric motor (“e-machine”) 610 illustrated in FIGS. 8-10 and shown schematically in FIG. 11. The e-machine can correspond to the previously described e-PTO motor; however, in general, the e-machine has a greater mechanical energy output than the e-PTO motor.

As shown in FIG. 11, the e-machine receives electrical energy from an energy storage system 612 via a power distribution system 614 and an inverter 616. The e-machine is coupled to the input of a gearbox 620, which is mounted on the energy storage system as shown in FIGS. 9 and 10 and as illustrated schematically in FIG. 11. The e-machine provides mechanical energy to the gearbox.

A hydraulic pump 630 is coupled to one output of the gearbox 620. The hydraulic pump receives mechanical energy from the e-machine 610 via the gearbox and provides hydraulic fluid flow to the hydraulic cylinders 142, 144, 146 as previously described for the embodiment of FIGS. 1-5.

A hydrostatic transmission (HST) pump 640 is coupled to a second output of the gearbox 620. The HST pump receives energy from the e-machine 610 via the gearbox and provides hydrostatic fluid flow to a first HST motor 642 and a second HST motor 644. The first HST motor provides mechanical energy to the first terrain-engagement member 120. The second HST motor provides mechanical energy to the second terrain-engagement member 122.

As shown in FIG. 11, the all-electric power generation system 600 includes a system controller 650 coupled to a user interface 652. The user interface represents controls in the operator cab 112 that an operator can manipulate to control the operations of the loader 100. The system controller is responsive to user commands from the user interface to issue control commands to the e-machine 610, to the gearbox 620, to a hydraulic controller (not shown) that controls the hydraulic cylinders 142, 144, and to the HST motors 642, 644. In the illustrated embodiment, the system controller is coupled to the controlled components via a conventional controller area network (CAN) bus 660. The system controller also receives information from the controlled components via the CAN bus. The system controller is responsive to the received information to confirm proper operation of the controlled components and to make any adjustments to the operation of the controlled components.

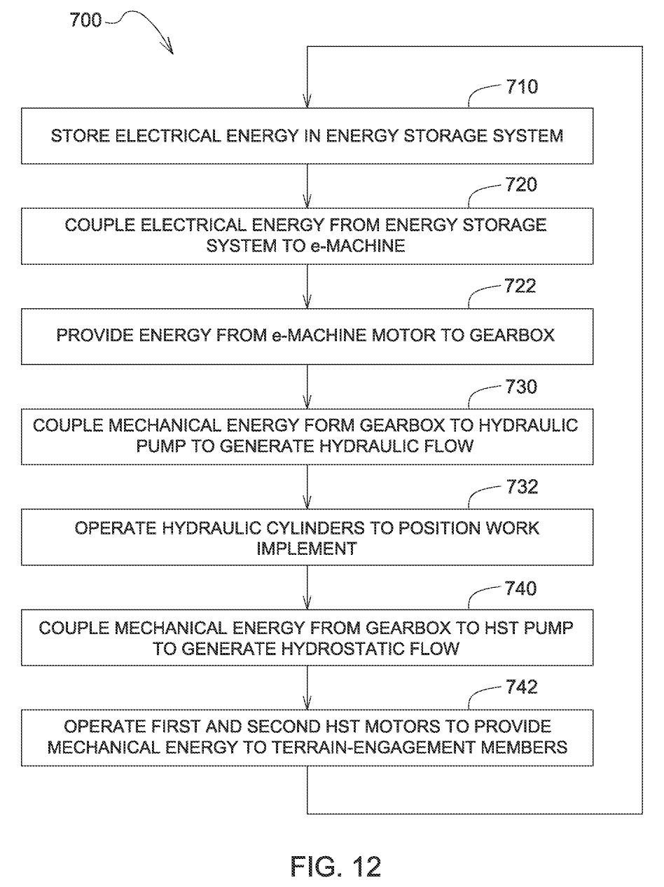

The all-electric power generation system 600 operates in accordance with a method illustrated by a flowchart 700 of FIG. 12. In a first action block 710, the method stores electrical energy from the external energy source 222 in the energy storage system 210. In a second action block 720, the method couples electrical energy from the energy storage system to the electric motor (“e-machine”) 610. In a third action block 722, the electric motor is selectively operable to provide mechanical energy to the input of the gearbox 620. In a fourth action block 730, the method couples mechanical energy from the gearbox to the hydraulic pump 630, which provides hydraulic flow to the hydraulic cylinders 142, 144. In a fifth action block 732, the hydraulic cylinders are selectively operable to position the work implement 130. In a sixth action block 740, the method couples mechanical energy from the gearbox to the HST pump 640, which provides hydrostatic fluid flow to the first HST motor 642 and the second HST motor 644. In a seventh action block 742, the HST motors are selectively operated to provide mechanical energy to the first terrain-engagement member 120 and the second terrain-engagement member 122. The method continues to loop in the seven action blocks as the system controller 650 issues commands via the CAN bus 660 to selectively operate the hydraulic pump and the traction motors as described above.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A power generation system for an electrically-powered off-highway machine having at least a first terrain-engagement member and a second terrain-engagement member for moving the off-highway machine over terrain and having at least one hydraulically powered implement for moving materials, the power generation system comprising:
an energy storage system that stores electrical energy;
a power distribution system coupled to the energy storage system to selectively provide DC electrical energy to the energy storage system and to selectively receive DC electrical energy from the energy storage system;
at least one charging port coupled to the power distribution system, the at least one charging port coupleable to a source of electrical energy to charge the energy storage system via the power distribution system;
a hydraulic pump that converts mechanical energy to hydraulic energy, the hydraulic pump coupled to the hydraulically powered implement to provide the hydraulic energy to the hydraulically powered implement;
at least one electric motor that receives electrical energy from the energy storage system via the power distribution system and that generates mechanical energy to drive the hydraulic pump, the first terrain-engagement member, and the second terrain-engagement member; and
a control system configured to control the power distribution system, the at least one electric motor, the hydraulic pump, and the first and second terrain-engagement members.

2. The power generation system of claim 1 further comprising at least one inverter coupled between the power distribution system and the at least one electric motor, the at least one inverter converting DC electrical energy from the power distribution system to AC electrical energy provided to the at least one electric motor.

3. The power generation system of claim 1 wherein the off-highway machine includes low-voltage auxiliary devices, and wherein the power generation system further comprises a DC-DC converter that converts DC electrical energy from the energy storage system at a first voltage to DC electrical energy at a second voltage, the second voltage lower than the first voltage, the DC electrical energy at the second voltage provided to the low-voltage accessories.

4. The power generation system of claim 1 wherein the off-highway machine includes high-voltage auxiliary devices, and wherein the power distribution system is coupled to the high-voltage auxiliary devices to provide DC electrical energy from the energy storage system to the high-voltage auxiliary devices.

5. The power generation system of claim 1 wherein the at least one charging port is coupled to a voltage conversion system having an input and an output, the input of the voltage conversion system coupleable to the source of AC electrical energy, the output of the voltage conversion system coupled to the energy storage system via the power distribution system to provide DC electrical energy to the energy storage system.

6. The power generation system of claim 1 wherein the at least one charging port comprises an input connector coupleable to the source of DC electrical energy, the input connector electrically coupled to the energy storage system via the power distribution system to provide DC electrical energy to the energy storage system.

7. The power generation system of claim 1 wherein the energy storage system comprises at least one battery.

8. The power generation system of claim 1 wherein the at least one electric motor comprises a first electric motor that provides mechanical energy to the first terrain-engagement member, a second electric motor that provides mechanical energy to the second terrain-engagement member, and a third electric motor that provides mechanical energy to the hydraulic pump.

9. The power generation system of claim 8 wherein:
the first electric motor is a motor/generator that is selectively operable as a motor to convert electrical energy to mechanical energy to drive the first terrain-engagement member and that is selectively operable as a generator to receive mechanical energy from the first terrain-engagement member and to generate electrical energy for storage in the energy storage system; and
the second electric motor is a motor/generator that is selectively operable as a motor to convert electrical energy to mechanical energy to drive the second terrain-engagement member and that is selectively operable as a generator to receive mechanical energy from the second terrain-engagement member and to generate electrical energy for storage in the energy storage system.

10. The power generation system of claim 9 further comprising:
a first inverter coupled between the power distribution system and the third electric motor, the first inverter converting DC electrical energy from the power distribution system to AC electrical energy to drive the third electric motor; and
at least a second inverter coupled between the power distribution system and the first electric motor and the second electric motor, the at least a second inverter operating bidirectionally to convert DC electrical energy from the power distribution system to AC electrical energy to drive at least one of the first electric motor and the second electric motor when the at least one of the first electric motor and the second electric motor is operating as a motor and to convert AC electrical energy from the at least one of the first electric motor and the second electric motor to DC electrical energy when the at least one of the first electric motor and the second electric motor is operating as a generator.

11. The power generation system of claim 9 further comprising:
a first inverter coupled between the power distribution system and the third electric motor, the first inverter converting DC electrical energy from the power distribution system to AC electrical energy to drive the first electric motor;
a second inverter coupled between the power distribution system and the first electric motor, the second inverter operating bidirectionally to convert DC electrical energy from the power distribution system to AC electrical energy to drive the first electric motor when the first electric motor is operating as a motor and to convert AC electrical energy from the first electric motor to DC electrical energy when the first electric motor is operating as a generator; and
a third inverter coupled between the power distribution system and the second electric motor, the third inverter operating bidirectionally to convert DC electrical energy from the power distribution system to AC electrical energy to drive the second electric motor when the second electric motor is operating as a motor and to convert AC electrical energy from the second electric motor to DC electrical energy when the second electric motor is operating as a generator.

12. The power generation system of claim 11 wherein the second inverter and the third inverter are implemented as a single dual inverter.

13. The power generation system of claim 8 wherein:
the energy storage system has a first side and a second side;
the first electric motor is mounted proximate to the first side of the energy storage system; and
the second electric motor is mounted proximate to the second side of the energy storage system.

13. The power generation system of claim 12 wherein:
the energy storage system has a third side orthogonal to the first side and orthogonal to the second side; and
the third electric motor is mounted proximate to the third side of the energy storage system.

14. The power generation system of claim 1 further comprising a gearbox, wherein:
the at least one electric motor is coupled to the gearbox to provide mechanical energy to the gearbox;
the hydraulic pump is coupled to the gearbox to receive mechanical energy from the at least one electric motor via the gearbox;
at least one hydrostatic pump is coupled to the gearbox to receive mechanical energy from the at least one electric motor and to provide hydrostatic energy;
a first hydrostatic motor is coupled to the at least one hydrostatic pump to receive hydrostatic energy from the at least one hydrostatic pump and to generate mechanical energy to drive the first terrain-engagement member; and
a second hydrostatic motor is coupled to the at least one hydrostatic pump to receive hydrostatic energy from the at least one hydrostatic pump and to generate mechanical energy to drive the second terrain-engagement member.

15. A method of operating an electrically-powered off-highway machine having at least a first terrain-engagement member and a second terrain-engagement member for moving the off-highway machine over terrain and having at least one hydraulically powered implement for moving materials, the method comprising:
storing electrical energy from an energy source in an energy storage system;
coupling electrical energy from the energy storage system to at least one electric motor, the at least one electric motor generating mechanical energy; and
selectively providing mechanical energy from the at least one electric motor to one or more of a hydraulic pump, the first terrain-engagement member, and the second terrain-engagement member.

16. The method of claim 15 wherein the at least one electric motor comprises:
a first electric motor selectively operable to provide mechanical energy to drive the hydraulic pump;
a second electric motor selectively operable to provide mechanical energy to drive the first terrain-engagement member; and
a third electric motor selectively operable to provide mechanical energy to drive the second terrain-engagement member.

17. The method of claim 15 further comprising:
coupling the at least one electric motor to a gearbox to provide mechanical energy to the gearbox;
coupling the hydraulic pump to the gearbox to receive mechanical energy from the at least one electric motor via the gearbox;
coupling at least one hydrostatic pump to the gearbox to receive mechanical energy from the at least one electric motor via the gearbox and to generate hydrostatic energy;
coupling a first hydrostatic motor to the at least one hydrostatic pump to receive hydrostatic energy from the at least one hydrostatic pump and to generate mechanical energy to drive the first terrain-engagement member; and
coupling a second hydrostatic motor to the at least one hydrostatic pump to receive hydrostatic energy from the at least one hydrostatic pump and to generate mechanical energy to drive the second terrain-engagement member.
